(19) United States
(12) Patent Application Publication
(10) Pub. No.: US 2016/0350754 A1
(43) Pub. Date: Dec. 1, 2016

(54) EXPENSE MANAGING SYSTEM, EXPENSE MANAGING APPARATUS, AND EXPENSE MANAGING METHOD

(71) Applicants: Mitsuru SATOH, Tokyo (JP); Yoshihiro OGURA, Kanagawa-ken (JP); Takeshi SHIMAZAKI, Kanagawa-ken (JP)

(72) Inventors: Mitsuru SATOH, Tokyo (JP); Yoshihiro OGURA, Kanagawa-ken (JP); Takeshi SHIMAZAKI, Kanagawa-ken (JP)

(21) Appl. No.: 15/162,287

(22) Filed: May 23, 2016

(30) Foreign Application Priority Data
May 27, 2015 (JP) 2015-107715

(51) Int. Cl. G06Q 20/40; G06Q 40/00; G06Q 20/32

(52) U.S. Cl. CPC G06Q 20/405; G06Q 20/3278; G06Q 40/12

(57) ABSTRACT

An expense managing system based on a payment information generated by paying a charge executed by a near field wireless communication. The expense managing system is configured to obtain the payment information, obtain added information to be associated with a subject of the charge when the charge is paid, generate expense request information to request for the charge to be approved as an expense based on the payment information obtained and the added information obtained. The system is further configured to approve the expense based on the expense request information, and settle the expense based on the payment information that is included in the expense request information.

### CROSS-REFERENCE TO RELATED APPLICATIONS

The present application claims priority to and incorporates by reference the entire contents of Japanese Patent Application No. 2015-107715 filed in Japan on May 27, 2015.

### BACKGROUND

1. Field of the Invention

The present application relates to an expense managing system, an expense managing apparatus, and an expense managing method.

2. Description of the Related Art

In recent years, when an employee settles an expense used in a business of the employee, a system generates expense request information, stores all of the generated expense request information into a memory, and simultaneously requests all of the generated expense request information to a manager. Therefore the employee can easily settle the expense.

### SUMMARY

It is an object of the present embodiments to at least partially solve the problems in the conventional technology.

According to an aspect of the present embodiments, an expense managing system based on a payment information generated by paying a charge executed by a near field wireless communication. Further, the expense managing system includes a payment information obtaining unit configured to obtain the payment information, an added information obtaining unit configured to obtain an added information to be associated with a subject of the charge when the charge is paid, an expense request information generating unit configured to generate an expense request information to request for the charge to be approved as an expense based on the payment information obtained by the payment information obtaining unit and the added information obtained by the added information obtaining unit, an expense approving unit configured to approve the expense based on the expense request information generated by the expense request information generating unit, and an expense settling unit configured to settle the expense based on the payment information that is included in the expense request information generated by the expense approving unit.

The above and other objects, features, advantages and technical and industrial significance of this application will be better understood by reading the following detailed description of presently preferred embodiments, when considered in connection with the accompanying drawings.

### BRIEF DESCRIPTION OF THE DRAWINGS

FIG. 1 is a diagram of an exemplary practical form of an expense managing system;

FIG. 2 is a block diagram of an exemplary hardware configuration of an information processing apparatus;

FIG. 3 is a block diagram of an exemplary function configuration of the information processing apparatus;

FIG. 4 is a block diagram of an exemplary function configuration of a client application;

FIG. 5 is a block diagram of an exemplary function configuration of an expense managing server;

FIG. 6 is a diagram of an exemplary contents of a company information data base;

FIG. 7 is a diagram of an exemplary contents of a user information data base;

FIG. 8 is a diagram of an exemplary contents of an expense request information of a transportation costs;

FIG. 9 is a diagram of an exemplary contents of the expense request information of an electronic payment;

FIG. 10 is a sequence diagram of an exemplary operation procedure of registering the expense request information;

FIG. 11 is a diagram of an exemplary contents of the transportation costs stored into IC card;

FIG. 12 is a diagram of an exemplary contents of the electronic payment stored into IC card;

FIG. 13 is a diagram of an exemplary login screen;

FIG. 14 is a diagram of an exemplary screen for selecting the expense request information when an applicant requests the transportation costs;

FIG. 15 is a diagram of an exemplary screen for selecting the expense request information when the applicant requests the electronic payment;

FIGS. 16A and 16B are sequence diagrams of an exemplary operation procedure of an expense request and an expense settling;

FIG. 17 is a diagram of an exemplary expense request screen when the applicant requests the transportation costs;

FIG. 18 is a diagram of an exemplary expense request screen when the applicant requests the electronic payment;

FIG. 19 is a diagram of an exemplary expense approving screen;

FIG. 20 is a diagram of an exemplary screen for confirming the expense request information in detail;

FIG. 21 is a flowchart of an exemplary operation procedure of the expense settling;

FIG. 22 is a diagram of an exemplary delete confirming screen when the applicant deletes the expense request information;

FIG. 23 is a diagram of an exemplary contents of a setting information for noticing the expense request;

FIG. 24 is a flowchart of an exemplary operation procedure for notifying the expense request;

FIG. 25 is a diagram of an exemplary screen for noticing the expense request; and

FIG. 26 is a diagram of an exemplary contents of an business trip information.

### DETAILED DESCRIPTION

Embodiments of an expense managing system, an expense managing apparatus, and an expense managing method according to the present embodiments will be described in detail below with reference to the attached drawings. In the expense managing system, an applicant requests an expense based on an expense information obtained from an electronic payment to be used Integrated Circuit (IC) card conformed to Near Field Communication (NFC). It is one of features of the present embodiment that the applicant requests the expense based on the expense information and added other information, so that a manager is provided auxiliary information which the manager refers to when determining whether the expense applied by the applicant is right or not, in the expense managing system.

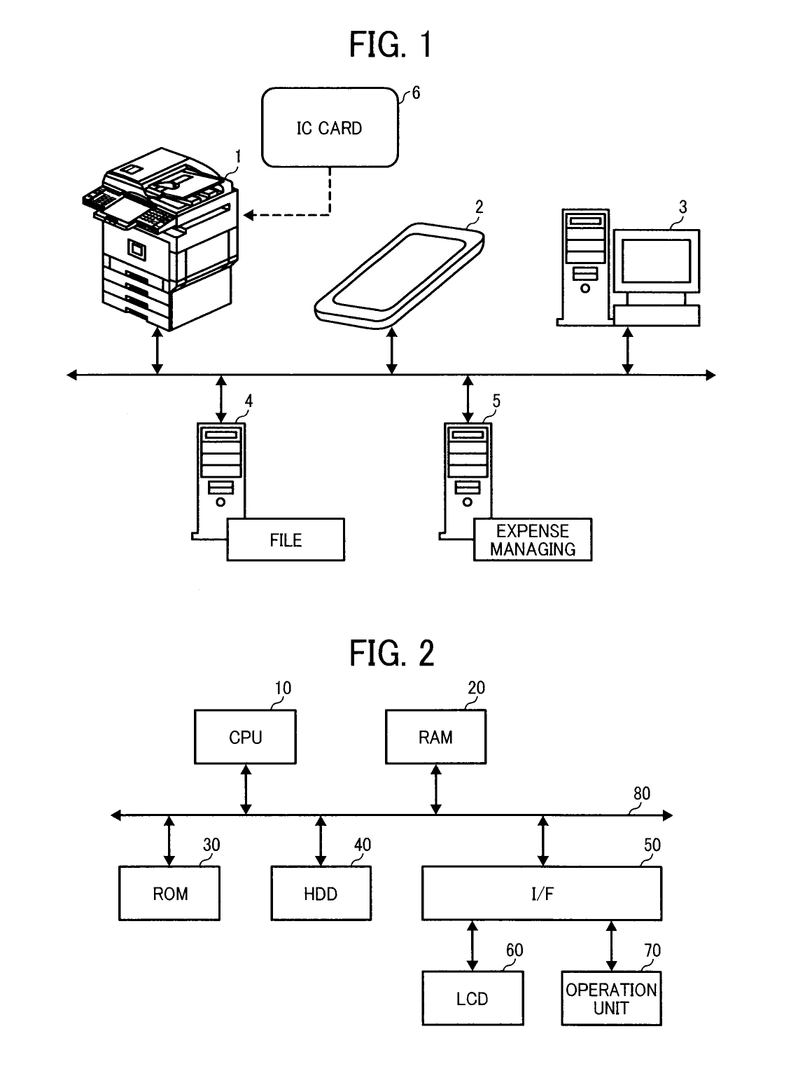

FIG. 1 is a diagram of an exemplary practical form of the expense managing system according to the present embodiment. As illustrated in FIG. 1, the expense managing system according to the present embodiment includes a Multi-Function Peripheral (MFP) 1, client terminal 2, client terminal 3, a file server 4, and an expense managing server 5 which are connected to each other via a network. The employee which uses the expense managing system temporarily pays with IC card 6.

The network to be connected by a plurality of the devices, for example, is a Local Area Network (LAN) to be limited to a specific area. The network may be connected by all of a plurality of the devices, or the network maybe connected by a part of the devices via the Internet, for example as a wide area network.

MFP 1 is an image processing apparatus placed in an office, and in the system, has a function of an information inputting unit on the system because MFP 1 obtains the information stored in IC card 6 by NFC. If the employee requests the expense with an image of a receipt, MFP 1 has a function of scanning the receipt.

The client terminal 2 is a portable information processing terminal, for example, a mobile phone, a smart phone, or a tablet terminal, and provides a user interface for the applicant which uses the system. The client terminal 2 has an interface of short-range communication to obtain the information stored in IC card 6.

The client terminal 3 is an information processing terminal, for example, a general Personal Computer (PC), and provides a user interface for a manager which has authority to approve the expense request. The manager confirms the information of the expense request on the system, and approves the expense request in response to an operation to the user interface.

The file server 4 stores expense request information received from the client terminal 2 in a memory, and sends the expense request information stored in the memory to the client terminal 2 in response to an instruction from the client terminal 2. The expense managing server 5 settles the expense request in response to approving the expense request by the manager.

In the embodiments, the client terminal 2 is a user's a private portable information processing terminal, however, the client terminal 2 may be an operation panel of MFP 1. As illustrated in FIG. 1, the file server 4 is, for example, a general server apparatus, however, it is possible that MFP 1 or the client terminal 2 (for example, a smartphone) has the functions of file server 4.

Next, an example hardware configuration of each of MFP 1, the client terminal 2, the client terminal 3, the file server 4, and the expense managing server 5 are described with reference to FIG. 2. MFP 1 has the hardware configuration of FIG. 2 and an engine to realize, for example, a scanner and a printer.

As illustrated in FIG. 2, an information processing apparatus according to the present embodiment includes the structure of the general server or PC. The information processing apparatus according to the present embodiment includes Central Processing Unit (CPU) 10, Random Access Memory (RAM) 20, Read Only Memory (ROM) 30, Hard Disk Drive (HDD) 40, and I/F 50, which are connected to each other via a bus 80. I/F 50 is connected to Liquid Crystal Display (LCD) 60 and an operation unit 70.

CPU 10 is a calculating means, CPU 10 controls the operation of the entire information processing apparatus. RAM 20 is a volatile storage medium in which can be read and wrote the information at a high speed, RAM 20 is used as work area when CPU 10 processes the information. ROM 30 is a read-only non-volatile storage medium, ROM 30 records programs, for example, firmware. HDD 40 is a non-volatile storage medium in which can be read and wrote the information, HDD 40 records, for example, Operating System (OS), the various control programs, and the application programs.

I/F 50 controls the connection between bus 80 and, for example, the various hardware or the network. LCD 60 is a visual user interface for user to confirm the condition of the information processing apparatus. The operation unit 70 is a user interface, for example, a keyboard and mouse, for a user to input information into the information processing apparatus. However, since the file server 4 and the expense managing server 5 according to the present embodiment are utilized as the server where a user does not operate, the description of the file server 4 and the expense managing server 5 including a user interface, for example, LCD 60 and the operation unit 70 is omitted.

With the above-described hardware configuration, the CPU 10 performs operations (functions) of the information processing apparatus in accordance with a program stored in the ROM 30 or a program loaded to the RAM 40 from a storage medium such as an Optical disk. Thereby, a software control part of the information processing apparatus can be implemented. By combining the software control part and the hardware configuration of the information processing apparatus, the below-described functions (function units) of MFP 1, the client terminal 2, the client terminal 3, the file server 4, and the expense managing server 5 can be implemented.

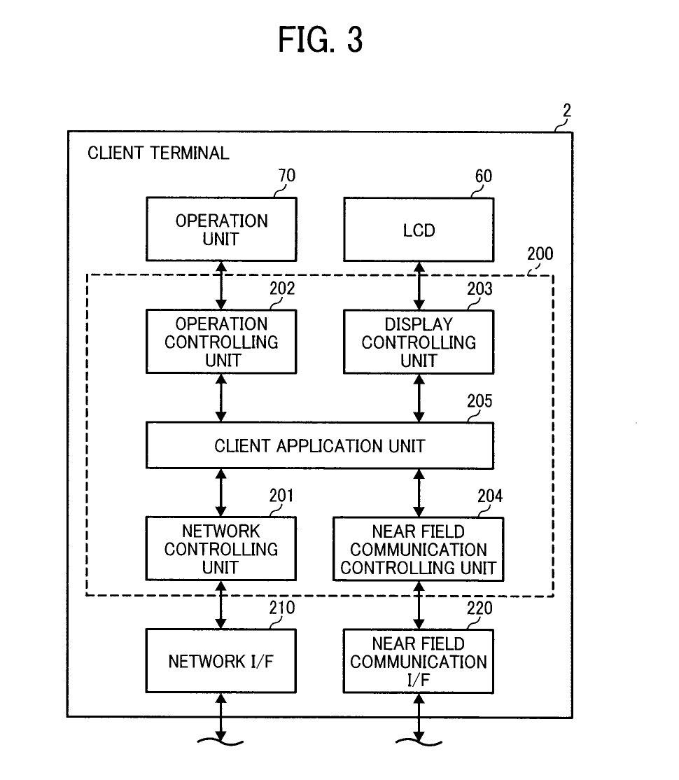

Next, a functional configuration of the client terminal 2 according to the present embodiment is described. As illustrated in FIG. 3, the client terminal 2 according to the present embodiment includes LCD 60 and the operation unit 70 of FIG. 2, a controller 200, a network I/F 210, and near field communication I/F 220. Further, the controller 200 includes a network controlling unit 201, an operation controlling unit 202, a display controlling unit 203, a near field communication controlling unit 204, and a client application unit 205.

The network I/F 210 includes an interface for enabling the client terminal 2 to communicate with other devices via a network. The network I/F 210 may be, for example, an Ethernet (registered trademark) interface, Bluetooth (registered trademark) interface, or Wireless Fidelity (WIFI) interface. The near field communication I/F 220 includes an interface for enabling the client terminal 2 to communicate with other devices via a near field communication. The near field communication I/F 220 may be, for example, an NFC interface. I/F 50 of FIG. 2 provides the function the network I/F 210 and the near field communication I/F 220.

The controller 200 includes a combination of software and hardware. The controller 200 provides a function of controlling the client terminal 2 as a control unit. The network controlling unit 201 obtains the input information via the network I/F 210. The network controlling unit 201 transmits the information to other devices via the network I/F 210.

The near field communication controlling unit 204 obtains the input information via the near field communication I/F 220. The near field communication controlling unit 204 transmits the information to other devices via the near field communication I/F 220. The near field communication controlling unit 204 according to the present embodiments obtains the information of electronic and transportation costs stored in IC card 6 via the near field communication I/F 220.

The operation controlling unit 202 obtains signals of operation contents which the user inputs to the operation unit 70. The operation controlling unit 202 inputs the operation contents to a module (for example, the client application 205) executed in the client terminal 2, for example. The display controlling unit 203, for example, Graphical User Interface (GUI) of the client application 205, displays the condition of the client terminal 2 on LCD 60.

The client application 205 is a software module for implementing a function enabling the client terminal 2. The client application 205 is constituted by software programs corresponding to the respective functions. The client application 205 according to the present embodiment includes a function to transmit the expense request information to the file server 4 based on the information obtained from IC card 6, a function to make the file server 4 store the expense request information, and a function to make the file server 4 transmit the expense request information for settling.

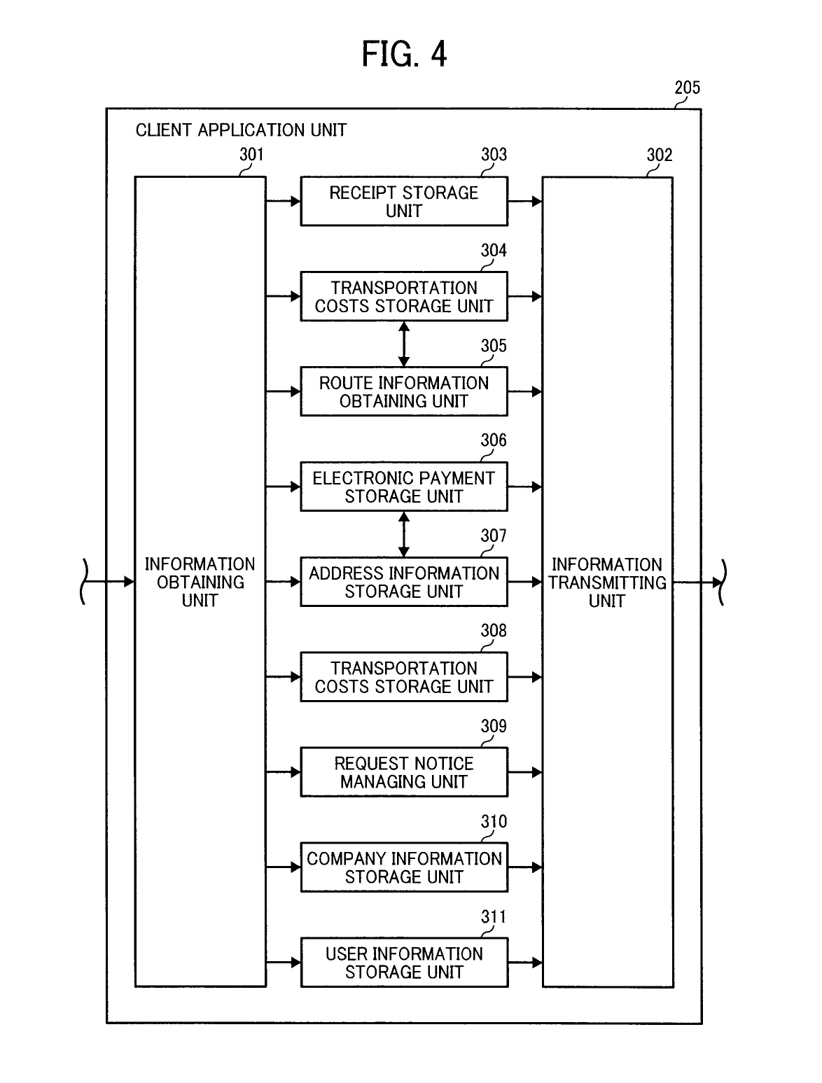

The functions included in the client application 205 according to the present embodiment is described with reference to FIG. 4. FIG. 4 is a block diagram of an exemplary function configuration of a client application 25 according to the present embodiment. As illustrated in FIG. 4, the client application 205 according to the present embodiment includes an information obtaining unit 301, an information transmitting unit 302, a receipt storage unit 303, a transportation costs storage unit 304, a route information obtaining unit 305, an electronic payment storage unit 306, an address information storage unit 307, a transportation costs storage unit 308, a request notice managing unit 309, a company information storage unit 310, and a user information storage unit 311.

The information obtaining unit 301 obtains the information from each units of the controller 200. The information transmitting unit 302 transmits the information to each units of the controller 200. The receipt storage unit 303 provides a function of transmitting the expense request information with an image of the receipt to the file server 4.

The transportation costs storage unit 304 provides a function of transmitting the information of the transportation costs obtained by the information obtaining unit 301 to the file server 4 in response to the user operation. The route information obtaining unit 305 provides a function of obtaining the information of a route used by a user when the user stores the information of the transportation costs, and adding the information of the route to the information of the transportation costs.

The electronic payment storage unit 306 provides a function of transmitting the information of the electronic payment obtained by the information obtaining unit 301 to the file server 4 in response to the user operation. The address information obtaining unit 307 provides a function of obtaining the information of the store's address used by a user when the user stores the information of the electronic payment, and adding the information of the address to the information of the electronic payment.

The transportation costs storage unit 308 provides a function of confirming the information of the expense request stored in the file server 4 and requesting that the expense managing server 5 settle the expense request in response to a user operation. The request notice managing unit 309 notices that the manager settles the expense request, based on the expense request information stored in the file server 4 and not settled by the expense managing server 5. The company information storage unit 310 provides a function of storing anew the company information managed by the expense managing server 5. The user information storage unit 311 provides a function of storing anew the user information managed by the expense managing server 5.

In this embodiment, the client application 205 is installed in the client terminal 2. Further, the client application 205 may be installed in MFP 1. The manager can approve the expense request information by the client application 205 to be installed in the client terminal 3.

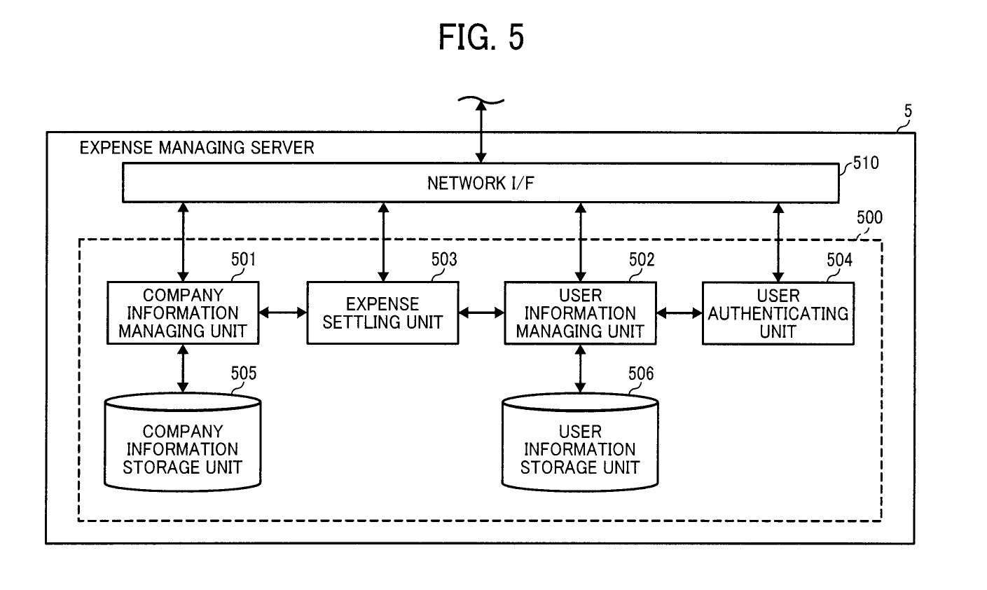

Next, the functions included in the expense managing server 5 according to the present embodiment is described with reference to FIG. 5. As illustrated in FIG. 5, the expense managing server 5 according to the present embodiment includes a controller 500 and Network I/F 510. The controller 500 includes a company information managing unit 501, a user information managing unit 502, an expense settling unit 503, a user authenticating unit 504, a company information storage unit 505, and a user information storage unit 506.

The network I/F 510 includes an interface for enabling the expense managing server 5 to communicate with other devices via a network. The network I/F 510 may be, for example, an Ethernet (registered trademark) interface, Universal Serial Bus (USB) interface, Bluetooth (registered trademark) interface, WIFI interface. The controller 500 includes a combination of software and hardware. The controller 500 provides a function of controlling the expense managing server 5 as a control unit.

The company information managing unit 501 provides a function of managing the company information, for example, storing anew the company information to the company information storage unit 505. The user information managing unit 502 provides a function of managing the user information, for example, storing anew the user information to the user information storage unit 506.

The expense settling unit 503 settles the expense based on the settlement requested by the client terminal 2. The user authenticating unit 504 authenticates the user based on the authentication requested by the client terminal 2.

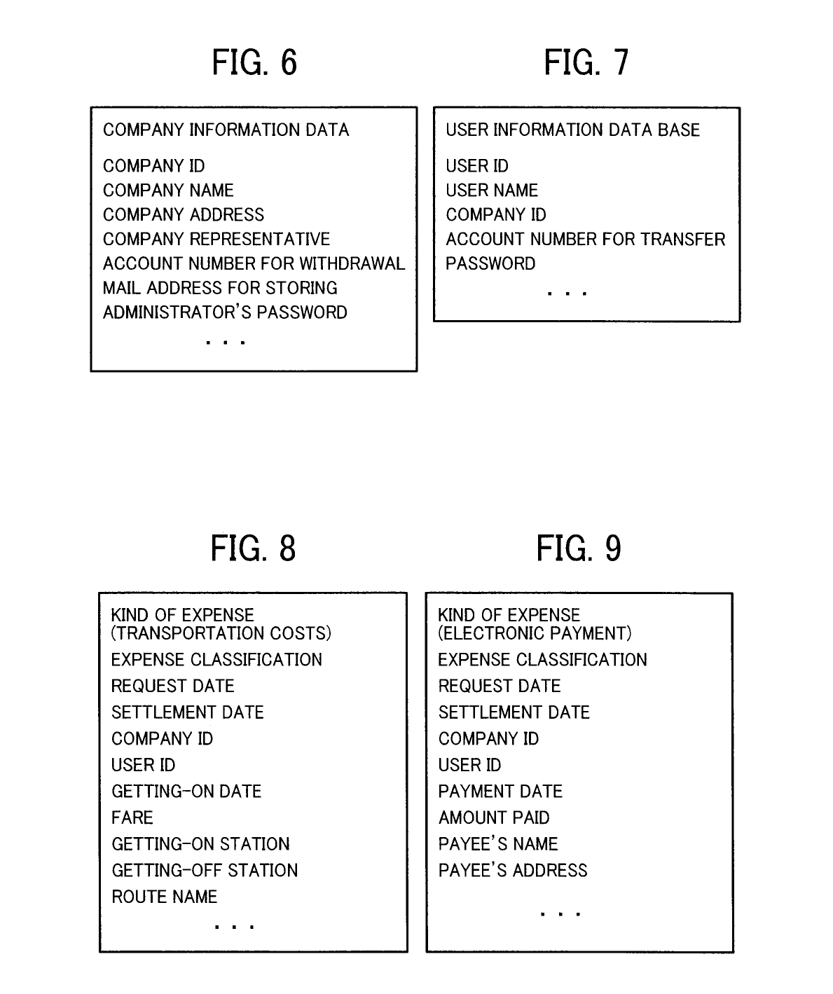

The company information storage unit 505 stores a company information data base. FIG. 6 is a diagram of an exemplary contents of a company information data base. As illustrated in FIG. 6, the company information data base according to the present embodiment includes information of “company ID”, “company name”, “company address”, “company representative”, “account number for withdrawal”, “mail address for storing”, and “administrator's password”.

“Company ID” is the identifier to identify the company. “Company name” is name of the company. “Company address” is the information indicating the location of the company. “Company representative” is the president's name of the company or the administrator's name of system. “Account number for withdrawal” is the information of the account number to be withdrawn the expense to transfer to the user when the expense requested by the user is settled.

“Mail address for storing” is the information of the transmission destination to store the expense request information generated by the client application 205 to the file server 4. “Administrator's password” is the password to be used in the login authentication when the administrator login as the administrator of the company's system.

The user information storage unit 506 stores a user information data base. FIG. 7 is a diagram of an exemplary contents of a user information data base. As illustrated in FIG. 7, the user information data base according to the present embodiment includes the information of “user ID”, “user name”, “company ID”, “account number for transfer”, and “password”. “User ID” is the identifier to identify the user.

“User name” is name of the user. “Company ID” is the identifier to identify the company which the user belongs. “Company ID” is the same as “Company ID” indicating FIG. 6. “Account number for transfer” is the information of the account number to be transferred the expense when the expense requested by the user is settled. “Password” is the password to be used in the login authentication when the user login to the system as the expense applicant.

Next, the expense request information stored in the file server 4 is described. The expense request according to the present embodiment is in a case of requesting the transportation costs of public transportation or in a case of requesting the electronic payment other than the transportation costs. FIG. 8 is a diagram of the expense request information based on the transportation costs according to the present embodiment. As illustrated in FIG. 8, the expense request information based on the transportation costs includes the information of “expense classification”, “request date”, “settlement date”, “company ID”, “user ID”, “getting-on date”, “fare”, “getting-on station”, “getting-off station” and “route name”.

“Kind of expense” is the information indicating whether the expense is transportation costs or the electronic payment. “Expense classification” of FIG. 8 is the information indicating the transportation costs. “Request date” is the information indicating date on which the expense request information is stored in the file server 4. “Settlement date” is the information indicating the date on which the user requests settling the expense request information to the expense managing server 5. “Company ID” is the identifier to identify the company to which the user settling the expense belongs. “Company ID” is the same as “Company ID” indicating FIG. 6.

“User ID” is the identifier to identify the user settling the expense. “User ID” is the same as “User ID” indicated in FIG. 7. “Getting-on date” is the information indicating the date on which the user uses the transportation with the transportation costs to be subject of the expense request. “Fare” is the information indicating amount of money to be subject of the expense request.

“Getting-on station” is the getting-on station of the transportation which the user uses with the transportation costs to be subject of the expense request. “Getting-off station” is the getting-off station of the transportation which the user uses with the transportation costs to be subject of the expense request. If the transportation is a bus, “getting-on station” and “getting-off station” are not a station but a bus stop. In any case, “getting-on station” and “getting-off station” are the information indicating a base of the transportation. “Route name” is the information indicating the route name of the transportation which the user uses with the transportation costs to be subject of the expense request.

FIG. 9 is a diagram of the expense request information based on the electronic payment according to the present embodiment. As illustrated in FIG. 9, the expense request information based on the electronic payment includes the information of “expense classification”, “request date”, “settlement date”, “company ID”, “user ID”, “payment date”, “amount paid”, “payee's name”, and “payee's address”.

“Payment date” is the information indicating the date on which the user performs the electronic payment to be the subject of the expense request. “Amount paid” is the information indicating the amount to be the subject of the expense request. “Payee's name” is the information indicating a name of store in which the user performs the electronic payment to be subject of the expense request. “Payee's address” is the information indicating an address of store in which the user performs the electronic payment to be subject of the expense request.

The expense request information includes information stored in IC card 6 when the user pays the transportation costs with IC card 6 or performs the electronic payment with IC card 6 in the store, and information added to the expense request information when the user request the expense. Thus, the information stored in IC card 6 are added other information in the electronic payment. Thereby, one of the features of the present embodiment that it is possible to assist the manager approving the expense request.

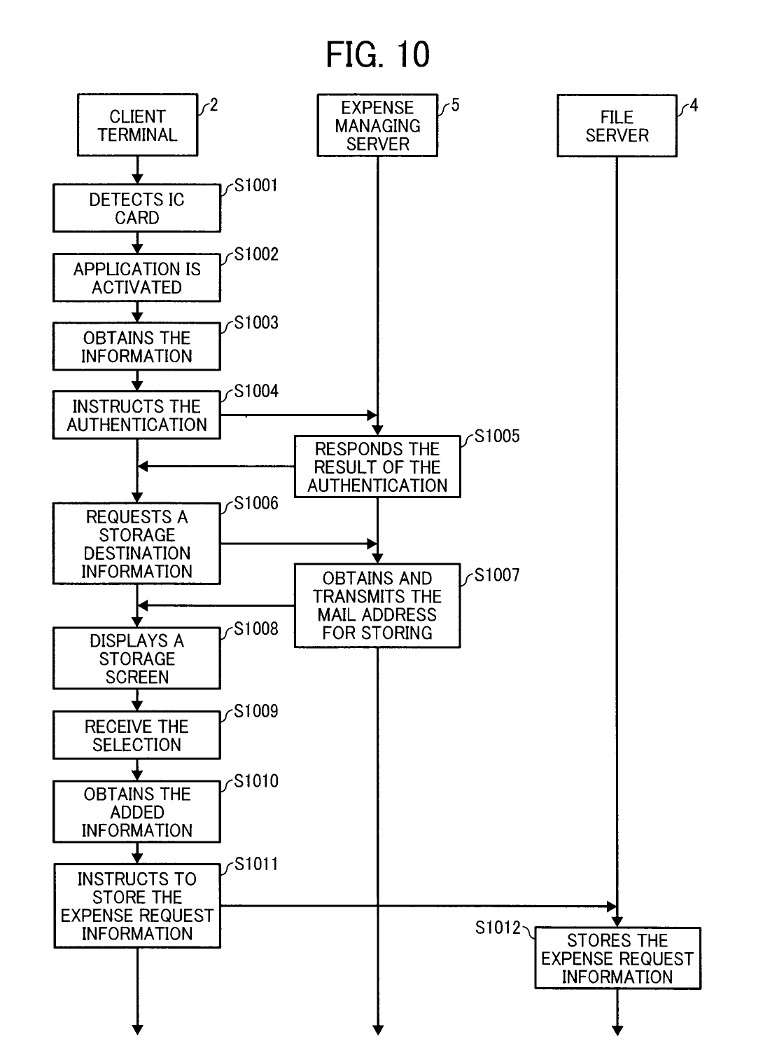

Next, in the system according to the present embodiment an operation of storing the expense request information to the file server 4 is described with reference to FIG. 10. In FIG. 10, the user pays with IC card 6 in the transportation or the store, thereby IC card 6 is stored with the payment information.

The user brings IC card 6 near to the client terminal 2. The client terminal 2 inputs the information stored in IC card 6 via the near field communication I/F 220. The near field communication I/F 220 is brought near to IC card 6, thereby the near field communication controlling unit 204 of the client terminal 2 detects IC card 6 (S1001).

When the near field communication controlling unit 204 detects IC card 6, the client application 205 is activated (S1002). When the client application 205 is activated because of IC card 6 approaching, the information obtaining unit 301 obtains the information stored in the IC card via the near field communication I/F 220 (S1003). Therefore, in S1003, the information obtaining unit 301 provides a function of the payment information obtaining unit.

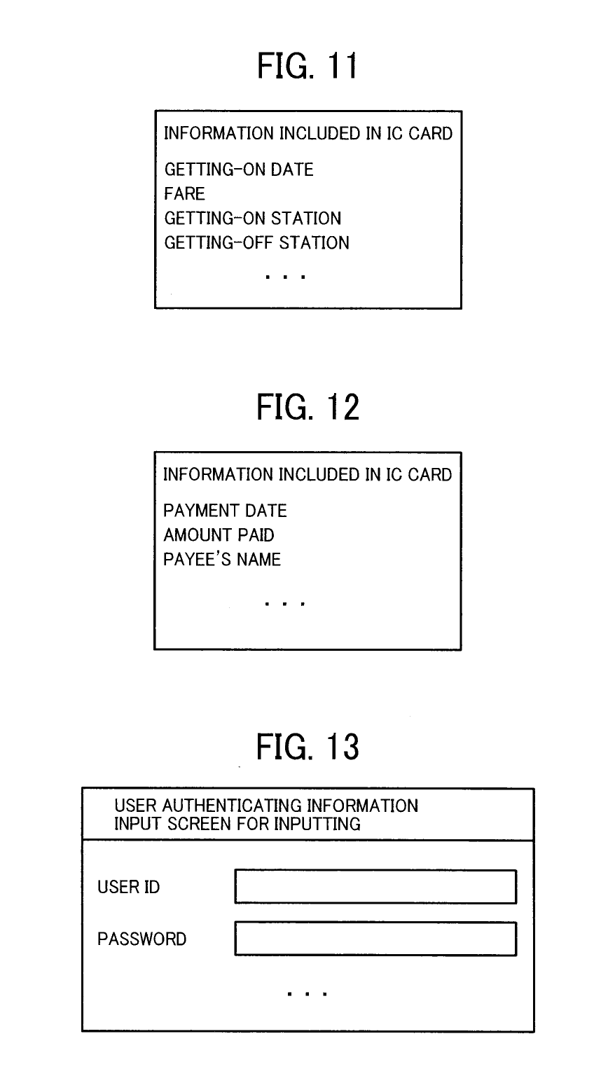

FIG. 11 is a diagram of the information of the transportation costs obtained in S1003. As illustrated in FIG. 11, the information of the transportation costs stored in IC card 6 includes the information of “getting-on date”, “fare”, “getting-on station”, and “getting-off station”. Each of the information is the same as each of the information of FIG. 8. FIG. 12 is a diagram of the information of the electronic payment obtained in S1003. As illustrated in FIG. 11, the information of the electronic payment stored in IC card 6 includes the information of “payment date”, “amount paid”, and “payee's name”. Each of the information is the same as each of the information of FIG. 9. The information illustrated in FIG. 11 and FIG. 12 are used as the payment information generated when the user pays the charge with the near field communication, for example, NFC.

By operating the client terminal 2, The user instructs the client terminal 2 to display a screen for storing the expense request information of the transportation costs or the electronic payment. Thereby, the client application 205 displays a user authenticating information input screen illustrated in FIG. 13 on LCD 60 via the display controlling unit 203. The user operates instructing the authentication by inputting the information into a screen illustrated in FIG. 13. Thereby, the information transmitting unit 302 of the client application 205 instructs the authentication to the expense managing server 5 (S1004).

The user authenticating unit 504 of the expense managing server 5 receiving the instruction of the authentication from the client terminal 2 obtains the instruction of the authentication. The user authenticating unit 504 responds with the result of the authentication to the client terminal 2 by referring to the information stored in the user information storage unit 506 via the user information managing unit 502 (S1005). In the client terminal which receives the result of the authentication from the expense managing server 5, the information obtaining unit 301 of the client application 205 obtains the result of the authentication. If the result of the authentication is OK, the information transmitting unit 302 requests a storage destination information of the expense request information to the expense managing server 5 (S1006).

The result of the authentication in S1005 includes the user information of the authenticated user. The user information is the same as each of the information of FIG. 7. The request for the storage destination in S1006 includes “company ID” to specify the company to which the authenticated user belongs. “Company ID” is included in the user information included in the result of the authentication in S1005.

The company information managing unit 501 of the expense managing server 5 receiving the request of the storage destination information searches a company information data base of the company information storage unit 505 based on “company ID” included in the request. The company information managing unit 501 obtains “mail address for storing” of the company corresponding to “company ID”, and transmits searched “Mail address for storing” to the client terminal 2 (S1007).

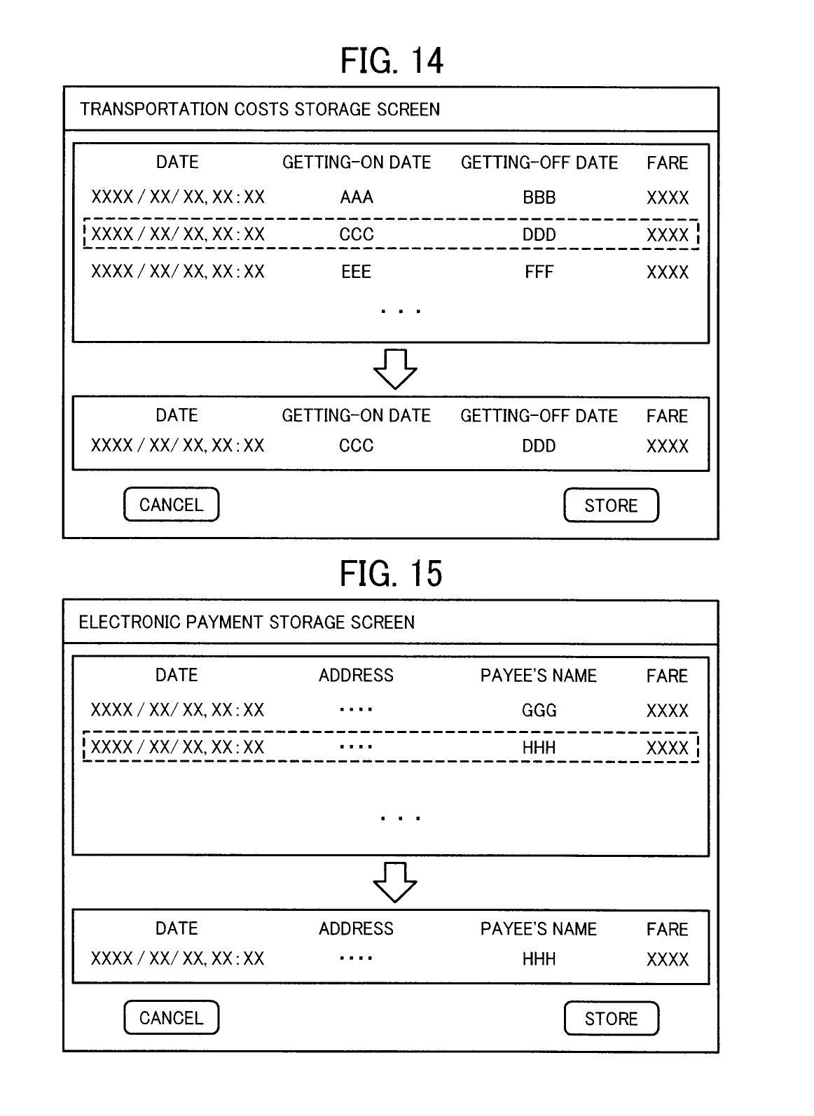

The client application 205 of the client terminal 2 receiving “mail address for storing” displays a storage screen of storing the expense request information (S1008). FIG. 14 is a diagram of the transportation costs storage screen in the expense request information. FIG. 15 is a diagram of the electronic payment storage screen in the expense request information.

As illustrated in FIG. 14, the payment information related to the transportation costs obtained from IC card 6 in S1003 is displayed in a list format on an upper area of the storage screen of the transportation costs. As illustrated in FIG. 15, the payment information related to the electronic payment obtained from IC card 6 in S1003 is displayed in a list format on an upper area of the storage screen of the electronic payment.

By the user operating the client terminal 2, the user selects the payment information displayed on the upper area of the storage screen as illustrated in FIG. 14 and FIG. 15. The contents of the user's operation is input in the information obtaining unit 301 of the client application 205. Therefore, the transportation costs storage unit 304 or the electronic payment storage unit 306 of the client application 205 receives the selection of the payment information to be the subject of generating the expense request information (S1009).

If the client application 205 receives the selection of the payment information, the client application 205 displays the selected payment information on a lower area of the storage screen as illustrated in FIG. 14 and FIG. 15. If the user operates a storage button of FIG. 14 and FIG. 15, the client application 205 obtains the added information (S1010).

If the client application 205 receives the transportation costs as the payment information, the client application 205 obtains the route information as the added information in S1010. The route information obtaining unit 305 of the client application 205 obtains the payment information selected by the user from the transportation costs storage unit 304.

The payment information of the transportation costs includes the information of “getting-on station” and “getting-off station”. The route information obtaining unit 305 instructs an external system to search the route information based on “getting-on station” and “getting-off station”. The route information obtaining unit 305 obtains the route information searched by the external system. Therefore, the route information obtaining unit 305 obtains the added information based on the payment information. When the route information obtaining unit 305 obtains the route information from the external system, it is possible to use a general Web service to be capable of searching the route information based on “getting-on station” and “getting-off station”. If the client application 205 receives the transportation costs as the payment information, the route information obtaining unit 305 provides a function of the added information obtaining unit.

If the client application 205 receives the electronic payment as the payment information, the client application 205 obtains the address information of the store where the user pays in S1010. The address information obtaining unit 307 of the client application 205 obtains the payment information selected by the user from the electronic payment storage unit 306.

The payment information of the electronic payment includes the information of “payee's name”. The address information obtaining unit 307 instructs the external system to search the payee's address information based on “payee's name”. The address information obtaining unit 307 obtains the payee's address information searched by the external system. When the address information obtaining unit 305 obtains the payee's address from the external system, it is possible to use a general Web service to be capable of searching the address based on “payee's name”. If the client application 205 receives the electronic payment as the payment information, the address information obtaining unit 307 provides a function of the added information obtaining unit.

When the client application 205 finishes to obtain the added information, the client application 205 generates the expense request information of FIG. 8 and FIG. 9. The client application 205 instructs the file server 4 to store the expense request information according to “Mail address for storing” obtained in S1006 and S1007 (S1011).

If the client application 205 instructs the file server 4 to store the transportation costs in S1011, the transportation costs storage unit 304 generates the expense request information of FIG. 8. The transportation costs storage unit 304 transmits an E-mail to “Mail address for storing”. If the client application 205 instructs the file server 4 to store the electronic payment, the electronic payment storage unit 306 generates the expense request information of FIG. 9. The electronic payment storage unit 306 transmits an E-mail to “Mail address for storing”. Therefore, each of the transportation costs storage unit 304 and the electronic payment storage unit 306 provides a function of the expense request information generating unit and the expense request information outputting unit.

The client application 205 instructs the file server to store the expense request information with the E-mail in S1011. When the file server 4 receives an instruction to store the expense request information, the file server 4 stores the received expense request information in memory (S1012). Thus, the expense request information of FIG. 8 and FIG. 9 is stored in the file server 4.

In the sequence diagram of FIG. 10, the user pays the charge with IC card 6 by, for the example, the user letting the client terminal 2 to read IC card 6. Alternatively, it may be, for example, that the user uses client terminal 2 to have a function of payment with the NFC of a smartphone.

In this case, so that the payment information of FIG. 11 and FIG. 12 is stored in the client terminal 2, the processes of S1001 and S1003 in FIG. 10 are not executed and the user manually activates the client application 205. The other processes are executed similarly to the processes of FIG. 10 in principle.

However, if the client terminal 2 has a function of obtaining a present position information, for example by the Global Positioning System (GPS), in the process of obtaining the added information in S1010 the client terminal 2 obtains the present position information instead of obtaining the “payee's address”. Therefore, if the user pays the charge with the electric payment, the client terminal 2 obtains the present position information. The client terminal 2 stored the present position information and the payment information in association with each other. It used the present position information stored in association with the payment information as “payee's address”, thereby searching based on the present position information is more accurate than searching based on the “payee's name”.

If the information obtained by the function of obtaining a present position information, for example GPS, is not in the form of address, the address information obtaining unit 307 obtains the address information based on the present position information. Thus, to obtain the address information based on the present position information can obtain the same effect as to obtain the address information based on the “payee's name”.

In the above-described embodiment, the expense is managed based on the payment information of FIG. 11 and FIG. 12 generated in paying the charge with NFC by the expense managing system. However, MFP 1 scans an image of a paper receipt, the scanned image may be used as the expense request information in the expense managing system.

In this case, a camera which the client terminal 2 has or the scanner which MFP 1 has, scans the paper receipt. Thereby the client terminal 2 or MFP 1 generates the image of the receipt. The information added the generated image of the receipt is stored in the file server 4 with the process of S1011 and S1012 as the expense request information of FIG. 8 or FIG. 9.

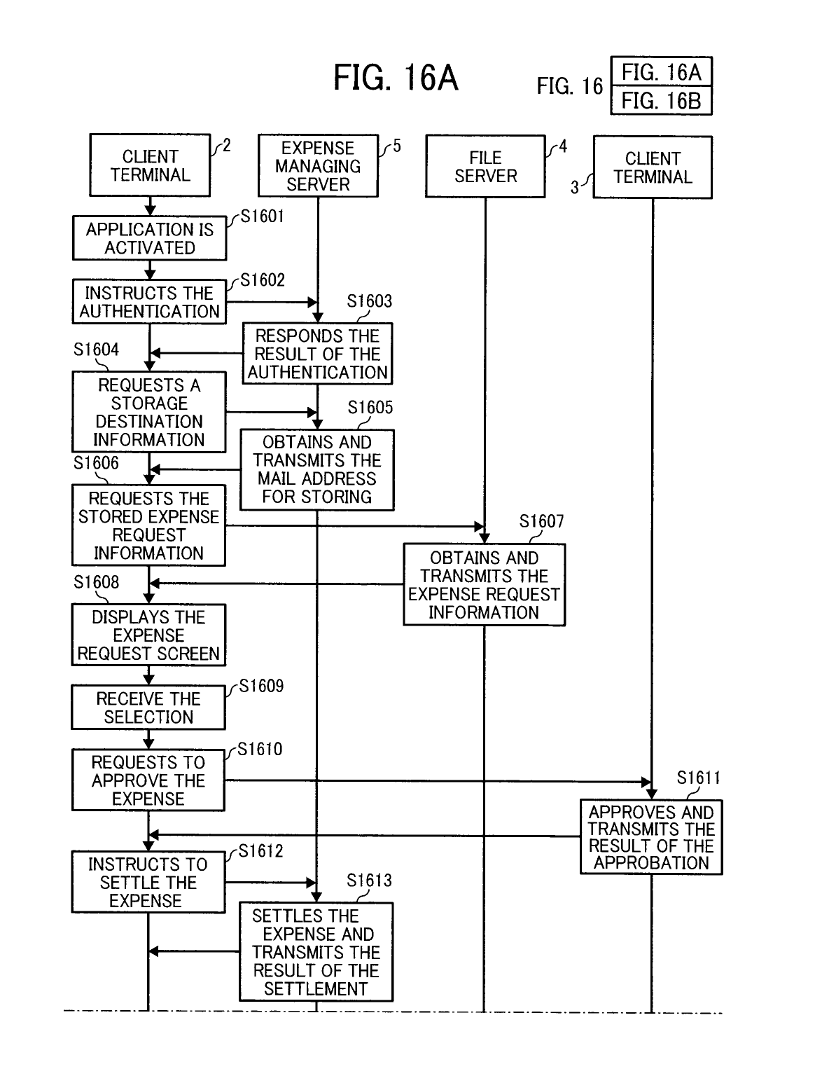

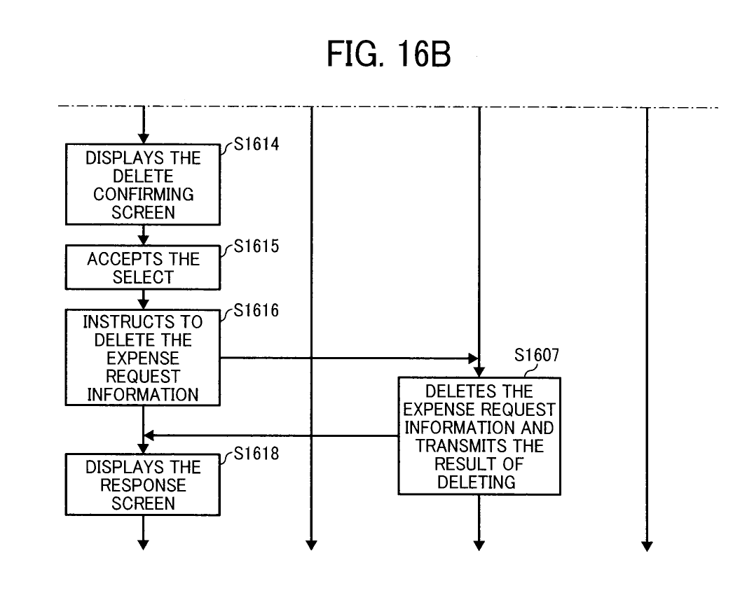

Next, after the file server 4 according to the present embodiment stores the expense request information, the processes that the user requests the manager to approve the expense is described with reference FIG. 16. When the use requests the manager to approve the expense, the user operates to activate an application for the approving request in the client terminal 2. Thereby, the client application 205 is activated in the client terminal 2 (S1601).

When the client application 205 is activated, the authentication process of login is executed by the same of the processes in S1004 and S1005 of FIG. 10 (S1602, S1603). Further, the client terminal 2 obtains the storage destination information of the expense request information by the same of the processes in S1006 and S1007 of FIG. 10 (S1604, S1605).

The expense requesting unit 308 which obtains the storage destination information of the expense request information, transmits the user ID login-authenticated to the obtained storage destination, and requests the stored expense request information (S1606). The file server 4 which receives the request of the stored expense request information, obtains the expense request information including the user ID transmitted from the client terminal 2 from the expense request information of FIG. 8 or FIG. 9, and transmits the expense request information to the client terminal 2 (S1607).

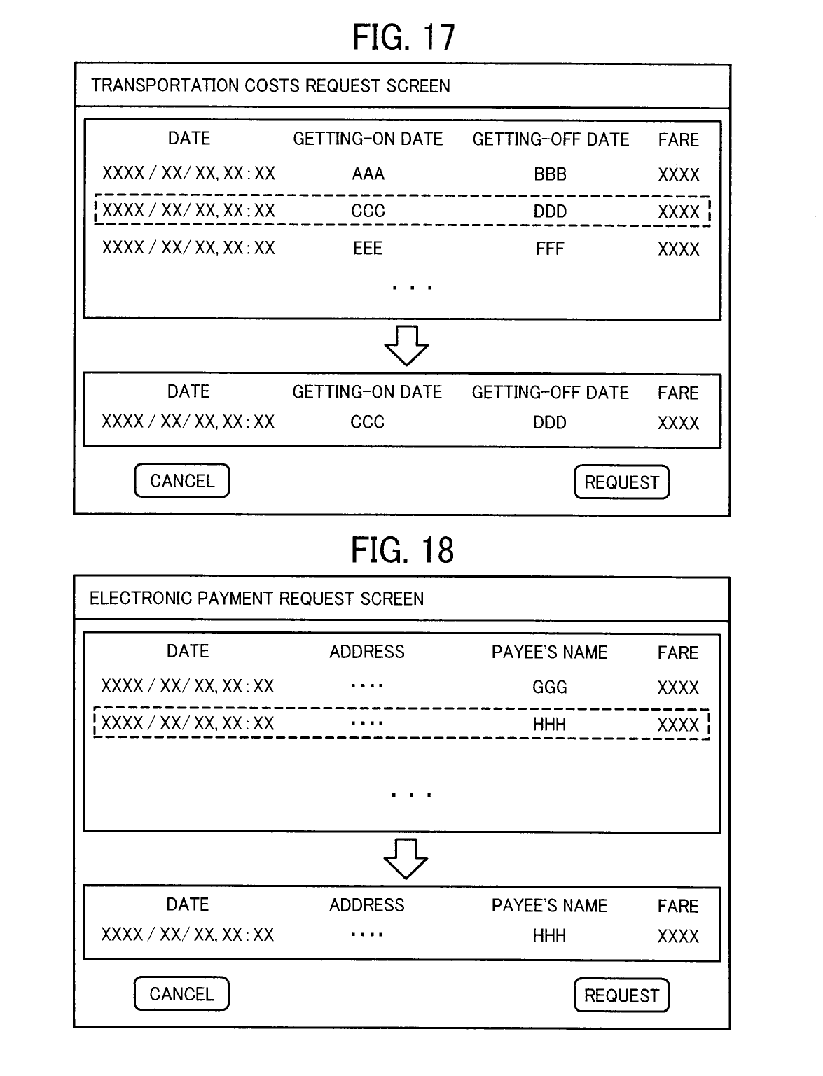

The expense requesting unit 308 which obtains the expense request information from the file server 4, displays the expense request screen based on the expense request information obtained from the file server 4 (S1608). FIG. 17 is a diagram of the expense request screen when the user requests the transportation costs. FIG. 18 is a diagram of an expense request screen when the user requests the electronic payment.

As illustrated in FIG. 17 or FIG. 18, the expense request information obtained from the file server 4 is displayed on the upper area of the expense request screen. The expense requesting unit 308 receives the selection in the list of the upper area in response to operation of the user (S1609). Thereby, the expense request information selected on the upper area is displayed on the lower area. Thus, when the user selects the expense request information to be subject of the request from the list of the upper area, the expense request information selected by the user is displayed on the lower area. The user operates a “storage” button, thereby the client terminals 2 executes the expense request.

When the user selects the expense request information and operates the “storage” button, the expense requesting unit 308 requests the manager to approve the expense (S1610). In S1610, the request to approve the expense includes the expense request information selected by the process of S1609.

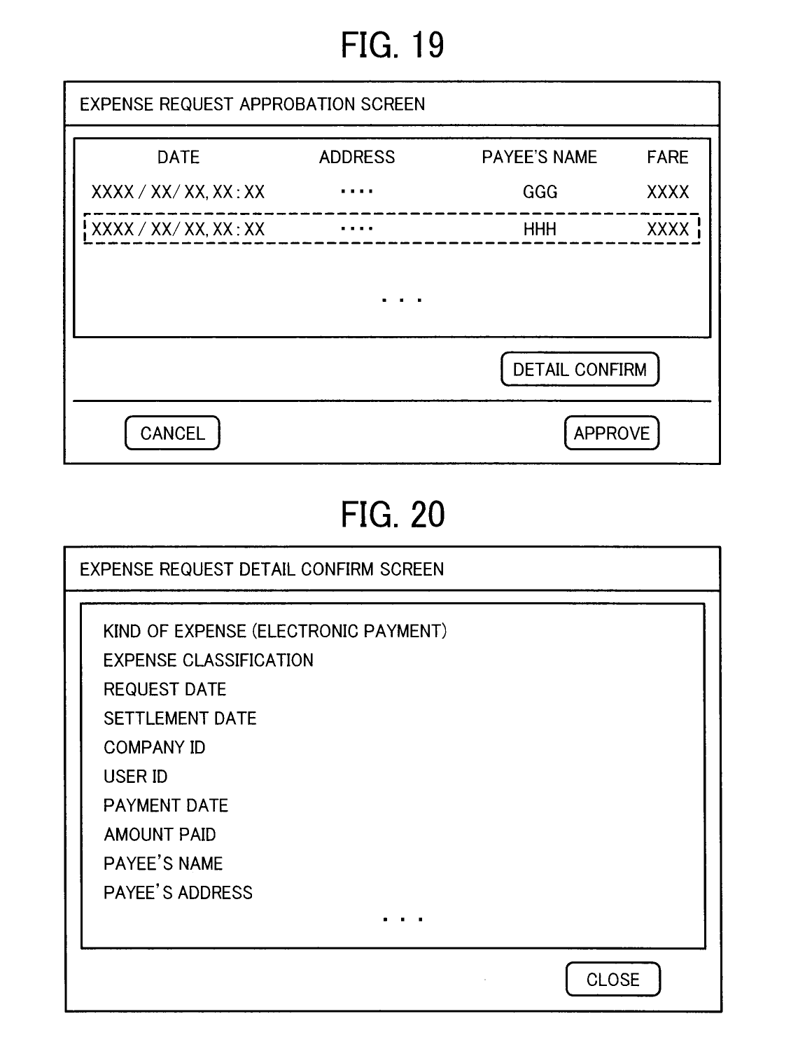

The manager which approves the expense request confirms the request to approve the expense via the client terminal 3. The client terminal 3 which receives the request to approve the expense approves the request in response to the approving operation by the manager and transmits the result of the approbation to the client terminal 2 (S1611). FIG. 19 is a diagram of an exemplary expense approving screen displayed in the client terminal 3 by the process in S1611.

As illustrated in FIG. 19, the list of the expense request information including the expense approbation request transmitted in S1610 is displayed on the expense request approving screen. As illustrated in FIG. 19, the manager selects the expense request information from the list of the expense request, and operates the “detail confirm” button. Thereby, as illustrated in FIG. 20 the screen for confirming the expense request information in detail which indicates the detail information of the expense request information is displayed. The client application 205 executing in the client terminal 3 generates the screen of FIG. 19 and FIG. 20.

The information displayed in the screen for confirming the expense request information in detail are all information included in the expense request information of FIG. 8 or FIG. 9. According to the present embodiment, in the process of S1010 of FIG. 10 the added information is added to the expense request information. If the expense request information is the transportation costs, the added information is the route information. If the expense request information is the electronic payment, the added information is the address information of the store in where the user pays.

So that the added information is added to the expense request information, as illustrated in FIG. 20, it is possible that the added information is displayed in the screen for the manager approving the expense request. Thereby, so that the information which is referred to by the manager when approving the expense request is increased, it is possible to support the manager properly when approving the expense request.

The manager operates for approving the expense request, and thereby the client terminal 3 transmits the result of the approbation to the client terminal 2. The client application 205 installed in the client terminal 3 provides this process. Thus, the client application 205 executed in the client terminal 3 provides a function of the expense approving unit. In the client terminal 2, the expense request unit 308 instructs the expense managing server 5 to settle the expense based on the result of the approbation (S1612). The instruction in S1612 includes the expense request information approved by the manager.

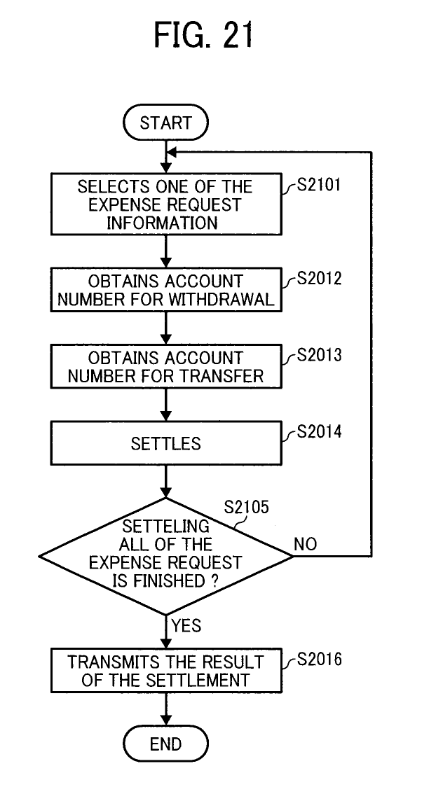

In the expense managing server 5 which receive the settlement instruction, the expense settling unit 503 obtains the expense request information included in the settlement instruction. Thus, after the expense settling unit 503 settles the expense, the expense settling unit 503 transmits the result of the settlement to the client terminal 2 (S1613). The processes executed by the expense settling unit 503 in S1613 is described with reference FIG. 21.

As illustrated in FIG. 21, the expense settling unit 503 selects one of the expense request information obtained (S2101). The expense settling unit 503 searches the company information data base based on “company ID” included in the expense request information, thereby the expense settling unit 503 obtains “account number for withdrawal” of FIG. 6 (S2102). So that the expense settling unit 503 searches the user information data base based on “user ID” included in the expense request information, the expense settling unit 503 obtains “account number for transfer” of FIG. 7 (S2103).

The expense settling unit 503 which obtains “account number for withdrawal” and “account number for transfer” settles “fare” or “amount paid” included in the expense request information based on the account number (S2104). Thereby, the expense is transferred from the account specified by “account number for withdrawal” to the account specified by “account number for transfer”.

The expense settling unit 503 performs the processes of S2101-S2104, the expense settling unit 503 repeats the processes until the processes are finished in all of the expense request information included in the received settlement instruction (S2105/NO). If the processes of S2101-S2104 are finished in all of the expense request information include in the received settlement instruction (S2105/YES), the expense settling unit 503 transmits the result of the settlement to the client terminal 2 which instructs the settlement (S2106), and the expense settling unit 503 finished the processes.

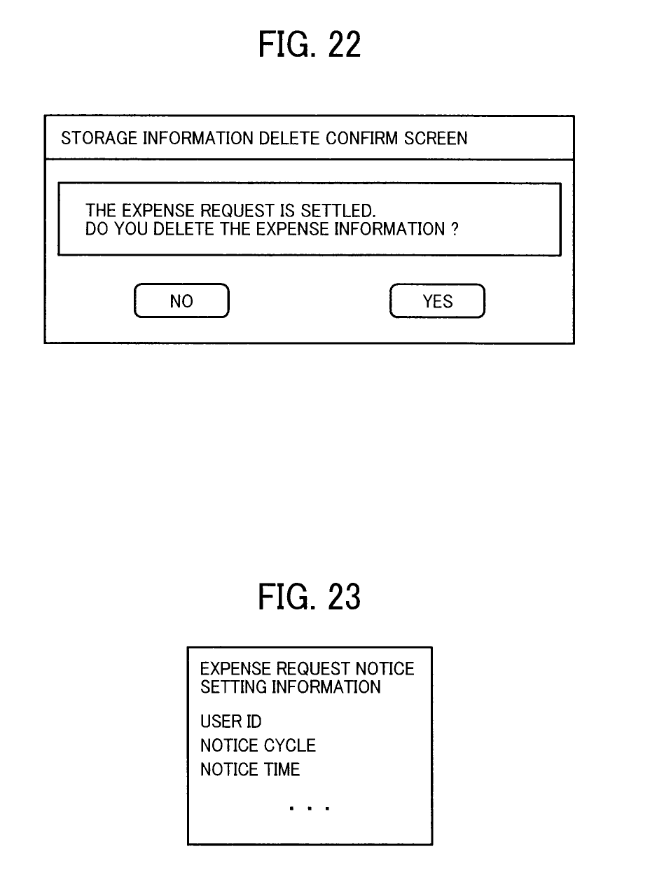

The expense requesting unit 308 in the client terminal 2 which receives the result of the settlement from the expense managing server 5 displays the delete confirming screen for deleting the stored expense request information to be settled by the expense managing server 5 (S1614). FIG. 22 is a diagram of the screen for confirming to delete the storage information displayed in S1614. If the user operates “YES” button in the screen of FIG. 22, the expense request unit 308 accepts the selection for deleting the expense request information (S1615), and the expense request unit 308 instructs the file server 4 to delete the expense request information selected by the user (S1616).

The file server 4 which accepts the instruction to delete the expense request information deletes the expense request information instructed by the client terminal 2. Next, the file server 4 transmits the result of deleting the expense request information to the client terminal 2 (S1617). The expense in the client terminal 2 which receives the result of deleting the expense request information from the file server 4 displays the response screen (S1618). The procedure of the expense request and the settlement is finished by these processes.

Next, the procedure that the client terminal 2 notifies the user to operate the expense request or the settlement in FIG. 16 in regard to the expense request information stored in the file server is described. The request notice managing unit 309 of the client application 205 stores the expense request notice setting information of FIG. 23 to notify the expense request.

As illustrated in FIG. 23, the expense request notice setting information according to the present embodiment includes the information of “user ID” to identify the user having the client terminal 2, “notice cycle” indicating frequency of notifying, and “notice time” indicate time of notifying. The request notice managing unit 309 notifies the user to operate the expense request by displaying the notice on the client terminal 2 based on the information of FIG. 23.

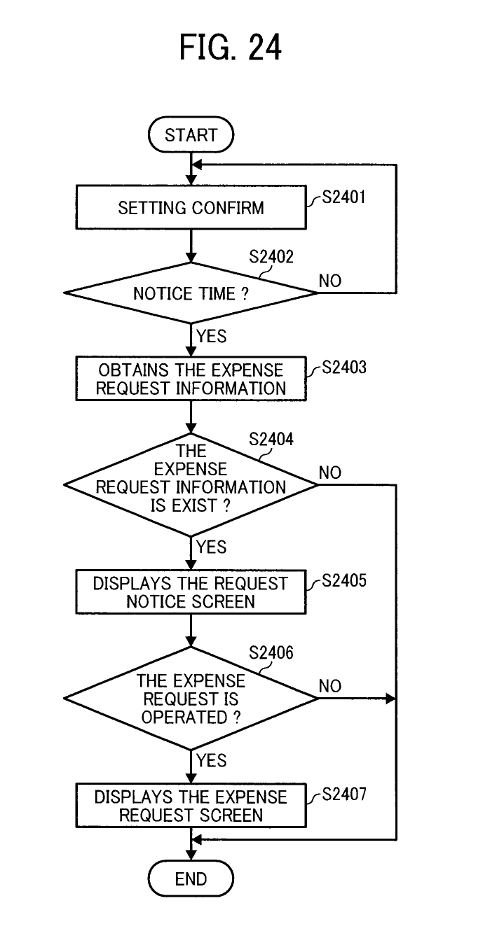

FIG. 24 is a flowchart of an operation procedure for notifying the expense request. As illustrated in FIG. 24, the request notice managing unit 309 confirms the setting information of FIG. 23 (S2401). In S2401, the request notice managing unit 309 confirms whether the current time is “notice time” or not, and whether a period of “notice cycle” has elapsed since the last request notice time or not, thereby the request notice managing unit 309 confirms whether the current time is a timing of the request notice or not.

Thereby, if the current time is not the timing of the request notice (S2402/NO), the request notice managing unit 309 regularly repeats the process of S2401. However, if the current time is the timing of the request notice (S2402/YES), the expense notice managing unit 309 obtains the expense request information in regard to “user ID” stored in the setting information from the file server 4 (S2403).

The process of S2403 is the same as the processes of S1606 and S1607 of FIG. 16. In this case, if it is necessary that the request notice managing unit 309 obtains the information of the location storing the expense request information from the expense managing server 5, the processes of S1604 and S1605 are executed. Further, if the login-authentication is necessary to obtain the information of the location storing the expense request information, the processes of S1602 and S1603 are executed. Therefore, a password in regard to “user ID” may be included in the request notice setting information.

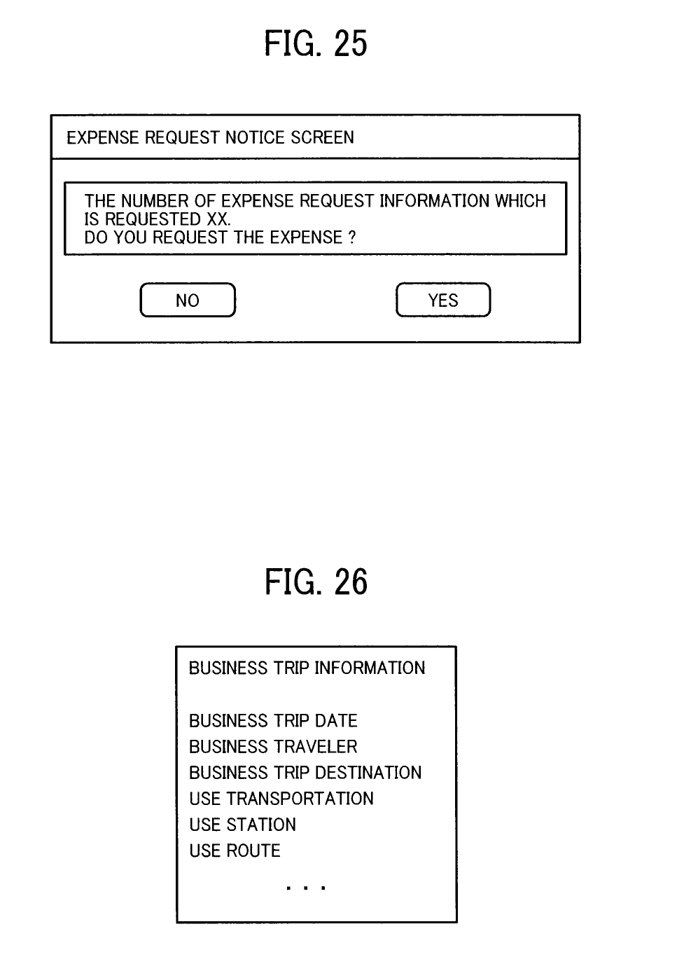

The request notice managing unit 309 which finishes execution of the process of S2403 confirms whether the request notice managing unit 309 obtains the expense request information from the file server 4 or not (S2404). If the request notice managing unit 309 doesn't obtain the expense request information (S2404/NO), the request notice managing unit 309 directly finishes execution of the process. However, if the request notice managing unit 309 obtains the expense request information (S2404/YES), the request notice managing unit 309 displays the request notice screen of FIG. 25 on the client terminal 2 (S2405).

As illustrated in FIG. 25, the request notice managing unit 309 displays the request notice screen including the notice of the existence of the expense request information not to be requested by the user, the number of the expense request information not to be requested by the user, and an operating unit to determine whether the user requested the expense or not. However, as illustrated in FIG. 19 the request notice managing unit 309 may be to display the list of the expense request information stored.

If the request notice managing unit accepts the operation not to request the expense when the user operates the “NO” button while displaying the screen of FIG. 25 (S2406/NO), the request notice managing unit 309 directly finishes execution of the process. However, If the request notice managing unit accept the operation to request the expense when the user operates “YES” button while displaying the screen of FIG. 25 (S2406/YES), the request notice managing unit 309 passes the process to the expense request unit 308. The expense request unit 308 displays the expense request screen of FIG. 17 or FIG. 18 (S2407).

By the process of S2407, the client terminal 2 similarly executes the process of S1608 of FIG. 16. Next, the processes are executed by the sequence diagram of FIG. 16, thereby the expense request is executed. By these processes the request notice managing unit 309 finishes execution of the process of the expense request.

Hence, with the expense managing system according to the above-described embodiment, the expense request information is generated to be based on the payment information of the charge for using the transportation or the charge by the electric payment used with NFC, for example an IC card. In this case, so that the payment information generated automatically is added to the information obtained in response to the situation of the payment as the added information, it is possible to help the manager to determine whether the expense is right or not when the manager approves the expense request.

If the payment information is the transportation costs, the added information is the route information. If the payment information is the payment in the payee, the added information is the address information. Therefore, the information in association with the space in where the user pays is obtained as the added information.

In the above-described embodiment, the manager approves the expense by the manager operating the client terminal 3. However, it is possible to execute automatically the processes of the approbation based on the added information of the feature according to the present embodiment.

For example, if the expense request is the transportation costs, it may be possible to execute automatically the process of the approbation based on comparison between the transportation costs and the business trip information or the going out information managed each other by the company. Such example is described below. FIG. 26 is a diagram of an exemplary business trip information in association with the user's business trip managed in the file server 4. As illustrated in FIG. 26, the business trip information includes the information of “business trip date”, “business traveler”, “business trip destination”, “use transportation”, “use station”, and “use route”. The business trip information of FIG. 26 is the business move information in association with move for business.

In the business trip information of FIG. 26, it is possible to automatically approve based on a comparison between the information of “business trip date”, “business traveler” and the information of “getting-on date”, “user ID” included in the expense request information of the transportation costs of FIG. 8. It is possible to automatically approve based on a comparison between the information of “use transportation”, “use station”, “use route” and the information of “getting-on station”, “getting-off station”, “route name”.

If the automatic comparison is executed to be based on the comparison, in S1610 of FIG. 16, the client terminal 2 instructs the expense managing server 5 to approve the expense. The expense settling unit 503 of the expense managing server 5 obtains the business trip information in regard to the comparison between “getting-on date” and “user ID” from the file server 4. Thus, the expense settling unit 503 provides a function of the business move information obtaining unit.

Thus, the processes of the automatic comparison is executed based on the comparison between the information “use transportation”, “use station”, “use route” as the business trip information obtained and the information of “getting-on station”, “getting-off station”, “route name”. By these processes, it is possible to automatically approve the expense and to ease the workload of the manager. Therefore, the information of “use route” is used as the information of the travel route of the business.

However, the automatic comparison may be executed as the pre-approbation before the approbation of the manager. For example, when in S1012 of FIG. 10 the expense request information is stored in the file server 4, the automatic comparison is executed. In this case, the file server 4 can execute the automatic comparison executed by the expense settling unit 503.

However, in another case to automatically approve the expense based on the business trip information, the business trip information automatically extracted may be displayed on the expense request approving screen. Thus, it is possible to help the manager to determine whether the expense is right or not, by providing the manager the information for the manager to refer to in determining whether the expense is right or not when the manager approves the expense request.

In the above-described embodiment, as illustrated in FIG. 10, for example, after the file server 4 stores the expense request information, further the processes of the expense request in FIG. 16 are executed in response to the user's operation. In an alternative example, for example, even if the processes of S1601-S1610 in FIG. 16 are not executed in regard to the expense request which is stored in the file server 4, the manager may be automatically instructed to approve the expense.

What is claimed is:

1. An expense managing system based on a payment information generated by paying a charge executed by a near field wireless communication, the expense managing system comprising:
processing circuitry configured to
obtain the payment information;
obtain added information to be associated with a subject of the charge when the charge is paid;
generate expense request information to request for the charge to be approved as an expense based on the payment information obtained and the added information obtained;
approve the expense based on the expense request information; and
settle the expense based on the payment information that is included in the expense request information.

2. The expense managing system according to claim 1, wherein
the processing circuitry is configured to obtain the added information based on the expense request information obtained.

3. The expense managing system according to claim 2, wherein
the payment information includes a first information to be associated with a base of transportation facilities used by an user that is generated when the user uses the transportation facilities, and
the processing circuitry is configured to obtain a second information to be associated with a course of the transportation facilities as the added information, based on the first information.

4. The expense managing system according to claim 3,
wherein the processing circuitry is configured to obtain business trip information that is third information to be associated with a business trip, and
wherein the processing circuitry is configured to approve the expense based on comparing the business trip information with a travel route and the second information that is included in the expense request information.

5. The expense managing system according to claim 3, wherein the processing circuitry is configured to obtain business trip information that is third information to be associated with a business trip, and
wherein the processing circuitry is configured to extract the business trip information to be associated with the expense request information and generate a screen information for displaying the expense request information.

6. The expense managing system according to claim 1, wherein
the payment information is a fifth information generated by paying the charge with a portable information processing terminal having a near field communicating function, and
the processing circuitry is configured to obtain a sixth information indicating a place in which a user paid the charge as the added information, based on a location information obtained by a location information obtaining function installed on the portable information processing terminal, when the user pays the charge with the portable information processing terminal.

7. An expense managing apparatus based on a payment information generated by paying a charge executed by a near field wireless communication, the expense managing apparatus comprising:
processing circuitry configured to
obtain the payment information,
obtain an added information to be associated with a subject of the charge when the charge is paid,
generate expense request information to request for the charge to be approved as an expense based on the payment information obtained and the added information obtained, and
output the expense request information generated for approving.

8. An expense managing method based on a payment information generated by paying a charge executed by a near field wireless communication, the expense managing method comprising:
obtaining the payment information,
obtaining an added information to be associated with a subject of the charge when the charge is paid,
generating an expense request information to request for the charge to be approved as an expense based on the payment information obtained and the added information obtained, and
outputting the expense request information generated for approving.
